(19) United States
(12) Patent Application Publication
(10) Pub. No.: US 2009/0105373 A1
(43) Pub. Date: Apr. 23, 2009

(54) Highly Filled Colorant Composition for Colouring Olefinic and Non-Olefinic Plastics

(75) Inventors: Reinhold Kling, Gersthofen (DE); Uwe Bernhardt, Bad Ems (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT PRODUKTE (DEUTSCHLAND) GMBH, Frankfurt am Main (DE)

(21) Appl. No.: 11/920,358

(22) PCT Filed: May 3, 2006
(86) PCT No.: PCT/EP2006/004138

§ 371 Date: Jun. 23, 2008

(30) Foreign Application Priority Data
May 11, 2005 (DE) 10 2005 022 652.3

(51) Int. Cl. C08J 3/22; C08K 3/22; C08K 3/00; C08K 3/30; C08K 3/10; C08K 3/34; C08K 5/23; C08K 5/3415; C08K 5/3437; C08K 5/357; C08K 5/08

(52) U.S. Cl. 523/351; 524/502; 524/430; 524/401; 524/423; 524/407; 524/449; 524/434; 524/431; 524/442; 524/413; 524/435; 524/190; 524/88; 524/87; 524/96; 524/358

(57) ABSTRACT

Colorant composition finely divided colorants and two or more polyolefin waxes, the quantitatively greater fraction representing a metallocene wax, and the further waxes being polar or a polar non-metallocene-polyolefin waxes or copolymers of ethylene. All of the polyolefin waxes together make up at least 15% by weight of the formula, and melt between 70 and 15O0 C. The colorant composition of the invention features reduced dust and is used for masterbatch production.

The present invention relates to a highly filled colorant composition which improves the uniformity of dispersion of pigments in plastics.

The invention also relates to the use of copolymeric low-molecular-weight waxes for the preparation of masterbatches in which the waxes are to a substantial extent prepared by means of metallocene catalysts and have low drop point, high transparency, and low viscosity. Use of these waxes markedly improves the dispersion of pigments, pigment loading can be increased, better compatibility with various polymers is obtained, and it is possible to omit any polymeric carrier.

Plastics are usually colored by using pigment concentrates, known as masterbatches. The pigment concentrates, prepared by the extrusion process, have pigment contents in the range from 10 to 75% by weight and comprise a polymeric carrier, and also various further additives, such as waxes and other dispersing agents, which promote the incorporation process and ensure maximum uniformity of dispersion of the pigments.

Stringent requirements are placed upon these pigment concentrates: The pigments should have ideal dispersion, since inadequate dispersion of the pigments can lead to pigment agglomerates and to formation of specks in the final product, which may, for example, be a foil. Specks can also easily lead to inferior mechanical properties in the final product, which is subject to premature cracking.

The following single- or multistage processes are currently known for preparing dust-free preparations, in the form of pellets or of powder, of pigments and of dyes:

The premixes of pigment-carrier material can be prepared via cold mixing or via hot mixing. Following this, mixing can be carried out in the melt in a suitable extruder or in kneaders. This is followed by pelletization, milling, or spraying.

A cold mix is composed of suitable polymer carriers, such as polyethylene, polypropylene, or ethylene-vinyl acetate copolymer, and the like, and also of further dispersing agents, such as waxes, fatty acid derivatives, stearates, etc. The disadvantage of these mixtures is the inadequate prewetting of the pigments via the mixing process, and this is discernible in high levels of dusting.

In the hot-mixing process, the mixture comprises, as with cold mixing, carrier materials, and also waxes, but here the mixture is agglomerated by way of intensive introduction of frictional energy, giving freedom from dust and higher bulk density.

DE-A-15 44 830 discloses a pigment preparation in which the pigment particles have been encapsulated by an amorphous homo- or copolymer composed of propylene, 1-butene, and 1-hexene, or a propylene-ethylene block polymer. Filtration steps and drying steps are required when preparing the pigment preparation.

DE-A-12 39 093 describes carrier materials based on a mixture composed of an amorphous ethylene-propylene block copolymer with a crystalline polypropylene, for preparation of pigment concentrates.

DE-A-26 52 628 relates to the use of polypropylene waxes whose viscosity is from 500 to 5000 mPa·s (170° C.) and whose isotactic content is from 40 to 90%.

DE-A-195 16 387 achieves highly effective dispersion via a dispersing agent which comprises a mixture of different polyolefin components and of specific polyacrylates.

JP-A-88/88287 describes preparations composed of pigment, lubricant, fillers, and an amorphous polyolefin.

DE-A 26 08 600 relates to pigment concentrates for the coloring of thermoplastics, comprising pigment, polyolefin wax, an ethylene-vinyl acetate copolymer, and colloidal silica.

All of the pigment preparations hitherto used in industry for coloring of polymers preferably comprise the polymer to be colored and to some extent incompatible constituents. When used in other polymers, the known pigment preparations give weaker color and less brilliance for the same pigment content, because the carrier material is less advantageous. Specific masterbatches are more complicated, and cannot be prepared with high colorant concentrations equivalent to the property profile described below.

Operations for preparation of organic pigment masterbatches usually involve a two-stage process with pigment content of 40% by weight or less, since the high pigment content reduces the extrudate strength of the masterbatches produced. Strand pelletization is prior art for masterbatch preparation. One way of improving this would be to use polymers with low MFR, this being equivalent to relatively high melt strength and therefore implying less break-off of extrudate. However, dispersion of polymers whose MFR is relatively low is poorer in the final product, and a consequence of this is discernible color differences in the form of color streaks in the final product.

The object of the present invention consisted in achieving maximum loading of organic and inorganic pigments in dust-free colorant preparations for masterbatch production and polymer coloring, in order that the manufacture of compounded materials and the direct coloring of plastomers and elastomers can be achieved in an economically and environmentally advantageous manner using a unitary carrier system, thus giving high-quality products. The intention here is to omit a conventional polymeric carrier, thus firstly permitting preparation of masterbatches with markedly higher pigment content and secondly permitting use of the finished masterbatches in significantly more polymers with different chemical constitution than hitherto, because of increasing compatibility.

The invention achieves this object via a colorant composition composed of a mixture composed of wax and polymer, which comprises a substantial amount of a metallocene wax, i.e. a wax which is prepared in the presence of metallocenes as catalyst. The colorant composition thus prepared is compounded in a specific extrusion process to give color masterbatches, but it is also possible, as an alternative, to use the mixture directly for plastics coloring.

The present invention provides a colorant composition, comprising
i) one or more metallocene polyolefin waxes,
ii) one or more waxes selected from polar and non-polar non-metallocene polyolefin waxes, and
iii) if appropriate, one or more copolymers of ethylene,
iv) and one or more finely dispersed colorants,
   the characterizing feature being that it comprises at least 15% by weight, based on the total weight of the colorant composition, of wax and/or copolymers of ethylene, and that the copolymers or waxes present in the colorant composition comprise at least 50% by weight of polypropylene metallocene wax.

All of the wax-like or polymeric constituents of the carrier melt at from 50 to 150° C.

Colorant compositions preferred according to the invention comprise from 30 to 85% by weight, preferably from 35 to 80% by weight, of an organic or inorganic pigment, and from 7.5 to 42.5% by weight, preferably from 8.5 to 40% by weight, of the metallocene polyolefin wax. The colorant composition preferred according to the invention can also comprise from 0.1 to 30% by weight, preferably from 0.5 to 25% by weight, of functional content for improvement of wetting and of compatibility, in the form of non-metallocene polyolefin waxes or copolymers of ethylene, and also from 0 to 15% by weight of conventional fillers or additives.

The waxes prepared in the presence of metallocene as catalyst are preferred. Copolymer waxes composed of propylene and from 0.1 to 50% of ethylene, and/or from 0.1 to 50% of at least one branched or unbranched 1-alkene having from 4 to 20 carbon atoms, whose drop point (ring/ball) is from 80 to 150° C. and whose melt viscosity, measured at a temperature of 170° C., is from 30 to 3000 mPa·s. The waxes prepared in the presence of metallocene as catalyst are substantially or completely amorphous, and can also have been polar-modified, if necessary.

Suitable non-metallocene polyolefin waxes are firstly in particular ethylene-vinyl acetate waxes whose drop point is from 90 to 120° C., and whose vinyl acetate content is from 1 to 30% by weight, and whose viscosity is from 50 to 1500 mPa·s at 140° C., and secondly non-polar, or else polar, non-metallocene waxes whose drop point is in the range from 90 to 120° C. and whose viscosity is smaller than 1500 mPa·s at 140° C.

Non-metallocene polyolefin waxes that can be used are homopolymers of ethylene or of higher 1-olefins having from 3 to 10 carbon atoms, or their copolymers with one another. The weight-average molar mass M_{w} of the polyolefin waxes is preferably from 1000 to 10 000 g/mol, and their number-average molar mass Mₙ is from 500 to 5000 g/mol.

Copolymers of ethylene can moreover be used advantageously as compatibilizers in the inventive colorant composition. Examples of copolymers of ethylene that can be used here are ethylene-methyl acrylate copolymers, ethylene-ethyl acrylate copolymers ethylene-butyl acrylate copolymers, and ethylene-vinyl acetate copolymers. The softening point of these products is typically below 40° C., their melting point is typically below 100° C., their comonomer content is typically from 10 to 20%, and their melt index is typically from 1 to 10 g/10 min, for 190° and 2.16 kg. They are termed “copolymers of ethylene” in the description hereinafter.

Metallocene compounds of the formula I are used for preparation of the metallocene polyolefin waxes used according to the invention.

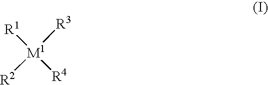

This formula also encompasses compounds of the formula Ia

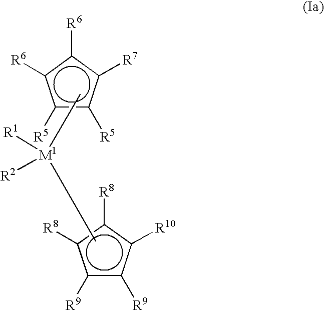

of the formula Ib

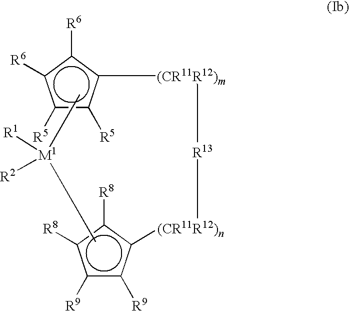

and of the formula Ic

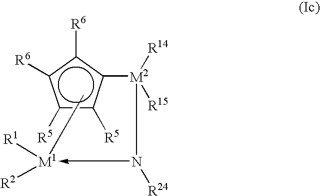

In the formulae I, Ia and Ib, M¹ is a metal of group IVb, Vb, or VIb of the Periodic Table, e.g. titanium, zirconium, hafnium, vanadium, niobium, tantalum, chromium, molybdenum, tungsten, preferably titanium, zirconium, hafnium.

R¹ and R² are identical or different and are a hydrogen atom, a C₁-C₁₀-alkyl group, preferably C₁-C₃-alkyl group, in particular methyl, a C₁-C₁₀-alkoxy group, preferably C₁-C₃-alkoxy group, a C₆-C₁₀-aryl group, preferably C₆-C₈-aryl group, a C₆-C₁₀-aryloxy group, preferably C₆-C₈-aryloxy group, a C₂-C₁₀-alkenyl group, preferably C₂-C₄-alkenyl group, a C₇-C₄₀-arylalkyl group, preferably C₇-C₁₀-arylalkyl group, a C₇-C₄₀-alkylaryl group, preferably C₇-C₁₂-alkylaryl group, a C₈-C₄₀-arylalkenyl group, preferably C₈-C₁₂-arylalkenyl group, or a halogen atom, preferably a chlorine atom.

R³ and R⁴ are identical or different and are a mono- or polynuclear hydrocarbon radical which can form a sandwich structure with the central atom M¹. R³ and R⁴ are preferably cyclopentadienyl, indenyl, tetrahydroindenyl, benzoindenyl, or fluorenyl, and the parent structures here may also bear additional substituents or may have bridging to one another. One of the radicals R³ and R⁴ may moreover be a substituted nitrogen atom, where R²⁴ is as defined for R¹⁷ and is preferably methyl, tert-butyl, or cyclohexyl.

R⁵R⁶, R⁷, R⁸, R⁹ and R¹⁰ are identical or different and are a hydrogen atom, a halogen atom, preferably a fluorine atom, chlorine atom, or bromine atom, a C₁-C₁₀-alkyl group, preferably C₁-C₄-alkyl group, a C₆-C₁₀-aryl group, preferably C₆-C₈-aryl group, a C₁-C₁₀-alkoxy group, preferably C₁-C₃-alkoxy group, an —NR¹⁶₂—, —SR¹⁶—, —OSiR¹⁶₃—, —SiR¹⁶₃—, or —PR¹⁶₂— radical, where R¹⁶ is a C₁-C₁₀-alkyl group, preferably C₁-C₃-alkyl group, or C₆-C₁₀-aryl group, preferably C₆-C₈-aryl group, or in the case of Si— or P-containing radicals, a halogen atom, preferably a chlorine atom, or any two adjacent radicals R⁵, R⁶, R⁷, R⁸, R⁹, or R¹⁰ form a ring with the carbon atoms connecting them. Particularly preferred ligands are the substituted compound structures derived from the parent structures cyclopentadienyl, indenyl, tetrahydroindenyl, benzoindenyl, or fluorenyl.

R¹³ is

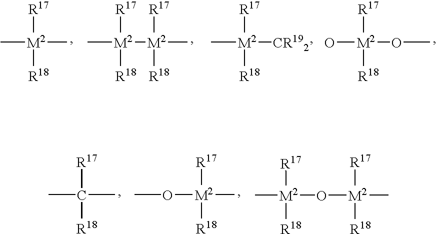

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸, and R¹⁹ are identical or different and are a hydrogen atom, a halogen atom, preferably a fluorine atom, chlorine atom, or bromine atom, a C₁-C₃₀-alkyl group, preferably C₁-C₄-alkyl group, in particular a methyl group, a C₁-C₁₀-fluoroalkyl group, preferably CF₃ group, a C₆-C₁₀-fluoroaryl group, preferably pentafluorophenyl group, a C₆-C₁₀-aryl group, preferably C₆-C₈-aryl group, a C₁-C₁₀-alkoxy group, preferably C₁-C₄-alkoxy group, in particular a methoxy group, a C₂-C₁₀-alkenyl group, preferably C₂-C₄-alkenyl group, a C₇-C₄₀-aralkyl group, preferably C₇-C₁₀-aralkyl group, a C₈-C₄₀-arylalkenyl group, preferably C₈-C₁₂-arylalkenyl group, or a C₇-C₄₀-alkylaryl group, preferably C₇-C₁₂-alkylaryl group, or R¹⁷ and R¹⁸, or R¹⁷ and R¹⁹ form a ring in each case together with the atoms connecting them.

M² is silicon, germanium, or tin, preferably silicon and germanium. R¹³ is preferably ═CR¹⁷R¹⁸, ═SiR¹⁷R¹⁸=GeR¹⁷R¹⁸, —O—, —S—, ═SO, ═PR¹⁷, or ═P(O)R¹⁷.

R¹¹ and R¹² are identical or different and are as defined for R¹⁷. m and n are identical or different and are zero, 1 or 2, preferably zero or 1, where m+n is zero, 1 or 2, preferably zero or 1.

R¹⁴ and R¹⁵ are as defined for R¹⁷ and R¹⁸.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienyidibenzylzirconium,
biscyclopentadienyldimethylzirconium,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenyldimethylzirconium,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
   and also each of the alkyl or aryl derivatives of these metallocene dichlorides.

Suitable cocatalysts are used to activate the single-center catalyst systems. Suitable cocatalysts for metallocenes of the formula I are organoaluminum compounds, in particular aluminoxanes, or else aluminum-free systems, such as R²⁰ₓNH₄₋ₓBR²¹₄, R²⁰ₓPH₄₋ₓBR²¹₄, R²⁰₃CBR²¹₄ or BR²¹₃. x in these formulae is a number from 1 to 4, and the radicals R²⁰ are identical or different, preferably identical, and are C₁-C₁₀-alkyl or C₆-C₁₈-aryl, or two radicals R²⁰ form a ring together with the atom connecting them, and the radicals R²¹ are identical or different, preferably identical, and are C₆-C₁₈-aryl, which may have substitution by alkyl, by haloalkyl, or by fluorine. In particular, R²⁰ is ethyl, propyl, butyl, or phenyl, and R²¹ is phenyl, pentafluorophenyl, 3,5-bistrifluoromethylphenyl, mesityl, xylyl, or tolyl.

A third component is also often required in order to maintain protection from polar catalyst poisons. Organoaluminum compounds are suitable for this purpose, examples being triethylaluminum, tributylaluminum, and others, and also mixtures.

As a function of the process, it is also possible to use supported single-center catalysts. Preference is given to catalyst systems in which the residual contents of support material and cocatalyst do not exceed a concentration of 100 ppm in the product.

Determination methods used here are: melt viscosities to DIN 53019 using a rotary viscometer, drop points to DIN 51801/2, and softening points by ring/ball to DIN EN 1427. Drop point is determined using Ubbelohde drop-point equipment to DIN 51801/2, and softening point using ring/ball equipment to DIN EN 1427.

The pigment concentrates can also comprise fillers or auxiliaries, such as antistatic agents, oleamide, partial fatty acid esters of glycerol, stearates, and antioxidants. It is also possible to use silica, and silicates, such as aluminum silicates, sodium silicate, and calcium silicates.

Colorants that can be used are organic and inorganic dyes and pigments. Organic pigments preferably used are azo pigments or disazo pigments, laked azo pigments or laked disazo pigments, or polycyclic pigments, preferably phthalocyanine pigments, quinacridone pigments, perylene pigments, dioxazine pigments, anthraquinone pigments, thioindigo pigments, diaryl pigments, or quinophthalone pigments.

Inorganic pigments for pigmentation are suitable metal oxides, mixed oxides, aluminum sulfates, chromates, metal powders, pearl-luster pigments (mica), luminescent colors, titanium oxides, cadmium-lead pigments, preferably iron oxides, carbon black, silicates, nickel titanates, cobalt pigments, or chromium oxides.

The required content of metallocene waxes and of other polyolefin waxes, or of copolymers of ethylene, depends on the surface structure and particle size of the colorants used, and is preferably intended to be selected appropriately therefor.

When organic pigments are used, a particularly advantageous colorant composition comprises from 30 to 75% by weight of organic pigment, from 7.5 to 42.5% by weight of the amorphous metallocene wax, from 0.1 to 20% by weight of ethylene-vinyl acetate wax, from 0.5 to 20% by weight of oxidized wax, or from 0.5 to 20% by weight of copolymers of ethylene, and also other fillers or additives in amounts of from 0 to 4% by weight.

When inorganic pigments are used, a particularly advantageous colorant composition comprises from 60 to 85% by weight of inorganic pigment, from 7.5 to 30% by weight of metallocene wax, and from 7.5 to 20% by weight of other olefin waxes or of copolymers of ethylene, and also from 0 to 2% by weight of additives.

Mixing specifications for carbon blacks are advantageously as for organic formulations, in order to obtain fully dispersed preparations. The inventive colorant compositions can also comprise further additives, such as fillers, for example lubricants, antistatic agents, antiblocking agents, antislip agents, and/or suspension stabilizers.

The premixing of the individual components is an important precondition during production of the product and can take place at room temperature in a suitable mixing apparatus. In the event that the mix is to be used in the form of dust-free powder mixture, a mixing phase using relatively high mixing energy follows, and it is advantageous here to heat in a first phase up to about 15 K below the softening point of the metallocene wax and in a second phase up to about 5 K below the softening point of the metallocene wax. The duration of the first phase is about 3 to 10 min, preferably 5 to 7 min, and the duration of the second phase is about 1 to 5 min, preferably 2 to 3 min. A cooling-mixing process follows the final mixing phase, cooling the colorant composition to about 30° C. The duration of this procedure is normally 3 to 15 min, preferably 5 to 10 minutes.

The heat energy can be introduced by way of friction during mixing, or by way of separate heating of the mixing trough, or by way of both methods. Pre-conditioning to about 25° C. is considered advantageous. Higher starting temperatures for hot mixing lead to clumping of the carrier and to formation of deposits on the base of the vessel. It is likewise advantageous to cool the mixing trough after the final mixing phase to the initial temperature.

In the cooling-mixing process which follows, up to 0.5% by weight of powder-flow aid, based on the entire mixture, can be added in order to improve flowability, the aim being to achieve grain size of from 0.05 to 3 mm in a dust-free powder mixture. If the handling form is not particularly important in subsequent processes, e.g. if the mixture is used in a further intensive mixing process, the preparation of a masterbatch can be omitted.

When the masterbatch is prepared in a corotating twin-screw system, it is advantageous to operate with a screw structure appropriately selected for the high wax content. The temperature profile is preferably lower than hitherto stated in the prior art. Underwater pelletization is advantageously used for preparation of the masterbatches.

The use of these preparations markedly improves pelletizability at these pigment loadings, not only for die-face pelletization systems but also for strand-pelletization systems.

The inventive colorant compositions are particularly used for preparation of masterbatches. The preparation process advantageously likewise operates with an initial mixing process. First, a mixture is prepared from the inventive colorant composition. The mixing process uses appropriate mixing technology. However, preparation of mixtures can be omitted if the individual components of a mix are introduced directly to the extrusion plant. However, in most cases this implies loss of quality in the final product, and industry therefore uses this method only for suitable pigments. Said mixture is then introduced by means of a suitable metering apparatus to an extrusion plant. This is generally a single- or twin-screw extruder, but continuous kneaders and batch kneaders are also used. This is followed by pelletization by way of a strand-pelletization system or die-face pelletization system, another possible method being spraying.

Individualized color shades are produced by blending monopreparations in a second extrusion pass, with one another or simply with polymer. A disadvantageous factor hitherto in arriving at individualized color shades has been the high consumption of monomasterbatches. Another factor increasing production costs has been the second extrusion process, and indeed in some cases a third extrusion process. Use of the inventive colorant compositions has eliminated these disadvantages.

The inventive colorant compositions can also be used to give compounded materials, or else for the direct coloring of plastics. Compounded materials are mixtures of polymers with abovementioned additives, fillers, and/or colorants.

The inventive colorant composition is used, by way of example, to color polyolefins, polyvinyl chloride (PVC), ethylene-vinyl acetate copolymers (EVA), styrene-acrylonitrile copolymers (SAN), polyethylene glycol terephthalate (PET), polybutylene glycol terephthalate (PBT) and their copolyesters, acrylonitrile-butadiene-styrene copolymers (ABS), polycarbonate (PC), polyethylene waxes, polypropylene waxes, amide waxes, hydrocarbon resins, montan waxes, aliphatic waxes, butyl and other rubber, paraffin and bitumen, and also some specialty polymers.

In the case of applications in plastics, specifically in masterbatch production, the inventive preparation is used in the same way as previous mixtures and masterbatches. It is possible to omit the conventional hot mixing of the entire formulation, frequently used in the case of organic pigments to improve wetting of the pigments.

Each of the following inventive examples uses a metallocene wax mixture prepared from the following waxes: metallocene PP wax, ethylene-vinyl acetate wax and polar and, respectively, non-polar, non-metallocene PE waxes and copolymers of ethylene where the materials have the following parameters (see below). The products are used in fine-grain form.

PP waxes a) and b) prepared using metallocene as catalyst:

| | | Viscosity at | Molecular | |
|---|---|---|---|---|
| | Drop point | 170° C. | weight | Density |
| | [° C.] | [mPa · s] | (Mₙ) [daltons] | [g/cm³] |
| a) | 88 | 200 | 3000 | 0.88 |
| b) | 90 | 1800 | 7000 | 0.88 |

VA wax:

| | Viscosity at | | |
|---|---|---|---|
| Drop point | 140° C. | Acid number | Density |
| [° C.] | [mPa · s] | [mg KOH/g] | [g/cm₃] |
| about 97 | about 350 | 10-12% of | 0.92 |
| | | vinyl acetate | |

Oxidized PE wax a) or non-polar PE wax b):

| | | Viscosity at | | |
|---|---|---|---|---|
| | Drop point | 120° C. | Acid number | Density |
| | [° C.] | [mPa · s] | [mg KOH/g] | [g/cm³] |
| a) | about 105 | about 300 | 17 | 0.92 |
| b) | about 118 | about 650 | 0 | 0.92 |

Copolymer of ethylene:

| Softening | Melting | | Et acrylate | |
|---|---|---|---|---|
| point | point | MFR viscosity | comonomer | Density |
| [° C.] | [° C.] | 190° C./2.16 kg | % | [g/cm³] |
| about 50-60 | about 85-98 | about 5-10 g/ | about 15-20 | about 0.94 |
| | | 10 min | | |

The materials are used in fine-grain form (sprayed or ground).

The inventive dye compositions were prepared as described below:

As mixture for extrusion:

| | |
|---|---|
| Mixer: | Henschel mixer, capacity 5 liters |
| Mix: | corresponding to the examples listed below |
| Premixing: | batch for about 4 to 6 min. at 700 rpm |

Extrusion then followed in a corotating twin-screw system with downstream underwater die-face pelletization.

Pellet diameter from 0.8 to 2 mm.

Or for use in the form of dust-free mixtures:

| | |
|---|---|
| Mixer: | Heating-cooling combination mixer, capacity 5 liters |
| Mix: | corresponding to the examples listed below |
| Premixing: | batch for about 2 min. at 350 rpm |

Mixing stage 1) and 2) and cooling phase

| | | |
|---|---|---|
| 1st phase: | 3100 rpm | T = from 50° C. to 60° C. |
| Mixing time: | about 5 min to 7 min | |
| 2nd phase: | 1500 rpm | T = from 65° C. to 85° C. |
| Mixing time: | about 2 min to 3 min | |
| Mixing with | to from 20 to 30° C. | |
| cooling: | | |
| Mixing time: | from 5 min to 10 min | |
| | at 360 rpm | |

Energy was introduced exclusively by way of friction. The average grain size of the resultant mixture was smaller than 1 mm.

### PREPARATION EXAMPLES

In the examples below, the following colorant compositions were prepared by processes described above. The metallocene waxes used in each case comprised the wax described above:
1) 50% by weight of C.I. Pigment Blue 15:1 (C.I. no. 74 160 Heuco blue 515303),
   15% by weight of non-polar PE wax and
   35% by weight of metallocene wax
2) 50% by weight of C.I. Pigment Blue 15:1 (C.I. no. 74 160 Heuco blue 515303),
   15% by weight of EVA wax and
   35% by weight of metallocene wax
3) 55% by weight of C.I. Pigment Blue 15:1 (C.I. no. 74 160 Heuco blue 515303),
   7.5% by weight of EVA wax and
   7.5% by weight of oxid. PE wax and
   30% by weight of metallocene wax
4) 50% by weight of C.I. Pigment Red 122 (C.I. no. 73 915),
   7.5% by weight of EVA wax and
   7.5% by weight of oxid. PE wax and
   35% by weight of metallocene wax
5) 50% by weight of C.I. Pigment Red 122 (C.I. no. 73 915),
   12.5% by weight of EVA wax and
   2.5% by weight of oxid. PE wax and
   35% by weight of metallocene wax
6) 50% by weight of C.I. Pigment Red 101 (C.I. no. 77491),
   15% by weight of EVA wax and
   35% by weight of metallocene wax
7) 60% by weight of Pigment Yellow 191
   15% by weight of copolymer of ethylene
   25% by weight of metallocene wax
8) 50% by weight of Pigment Red 48:3
   20% by weight of copolymer of ethylene
   30% by weight of metallocene wax

### APPLICATION EXAMPLES

The colorant compositions of Preparation Examples 1 to 8 were used directly in the form of masterbatch or in the form of powder for coloring of plastics. They can be subjected to further preparation processes in a corotating twin-screw system using a specific screw structure, and also using a relatively low temperature profile, to give masterbatches, which are used for the coloring of various polymers.

The following plastics were used:
1) acrylonitrile-butadiene-styrene copolymer (ABS);
2) ethylene-vinyl acetate copolymer (EVA);
3) polyester: polyethylene terephthalate (PET), polybutylene terephthalate (PBT);
4) polyethylene (HDPE);
5) polypropylene (PP);
6) styrene-acrylonitrile copolymers (SAN);
7) polystyrene (PS);
8) polycarbonate (PC).

Tests for color strength (ST 1/3), filter value, and foil quality, and also for fundamental mechanical properties.

Very good quality characteristics were achieved during the dispersion process, and foil quality is also assessed as good, this being characteristic of uniform pigment dispersion.

No significant impairment resulted from any effects on the mechanical properties of the colored polymers. Indeed, improvements were sometimes found.

Tensile strength, tensile strain, ultimate tensile strength, and ultimate tensile strain were tested using masterbatch concentrations of 1.5% and 0.5%. Tests on the straight polymers provided comparative values.

| | Test material | | | | | | | | |
|---|---|---|---|---|---|---|---|---|---|
| | ABS | EVA | HDPE | PBT | | | PP | | |
| | 967 | Greenflex | Hostalen | Ultradur | PC | PET | Moplen | PS | SAN |
| | KQ | ML30 | GC7260 | B2550 | Lexan 124R | Polyclear T86 | HP300 | 325-30 | M60 |
| Tensile strength | | | | | | | | | |
| N/mm² (EN ISO 527) | | | | | | | | | |
| uncolored | 52.3 | 13.9 | 29.8 | 65.6 | 64.9 | 76.9 | 40.1 | 51.9 | 75 |
| 1.5% RT 122 | 52.3 | 14.7 | 32.5 | 66.5 | 64.5 | 73.5 | 42.9 | 52.2 | 73.7 |
| Ex. 4 | | | | | | | | | |
| 0.5% RT 122 | 53.2 | 13.9 | — | 66.8 | 63.8 | 80.5 | — | 52.5 | 75.8 |
| Ex. 4 | | | | | | | | | |
| Tensile strain | | | | | | | | | |
| % (EN ISO 527) | | | | | | | | | |
| uncolored | 4.1 | 7.9 | 8.4 | 4.5 | 6.3 | 6 | 10.1 | 2.8 | 3.1 |
| 1.5% RT 122 | 4.2 | 7.8 | 7.4 | 4.6 | 6.2 | 5.9 | 8.2 | 2.6 | 3 |
| Ex. 4 | | | | | | | | | |
| 0.5% RT 122 | 4.3 | 8.49 | — | 4.5 | 6.3 | 6 | — | 2.5 | 3 |
| Ex. 4 | | | | | | | | | |
| Ultimate tensile strength | | | | | | | | | |
| N/mm² (EN ISO 527) | | | | | | | | | |
| uncolored | 52.3 | 12.7 | 29.8 | 49.6 | 70 | 21.5 | 25.4 | 51.3 | 74.5 |
| 1.5% RT 122 | 52.3 | 13.6 | 18 | 54.9 | 67.7 | 25.9 | 12.6 | 50.5 | 73.7 |
| Ex. 4 | | | | | | | | | |
| 0.5% RT 122 | 53.2 | 12.8 | — | 57.9 | 66.7 | 27.7 | — | 51.7 | 75.8 |
| Ex. 4 | | | | | | | | | |
| Ultimate tensile strain | | | | | | | | | |
| % (EN ISO 527) | | | | | | | | | |
| uncolored | 2.88 | 8.29 | 7.79 | 4.2 | 9.48 | 3.42 | 13.3 | 3 | 3.1 |
| 1.5% RT 122 | 1.81 | 8.31 | 6.48 | 1.18 | 9.53 | 3.75 | 13.8 | 3 | 3 |
| Ex. 4 | | | | | | | | | |
| 0.5% RT 122 | 1.9 | 8.96 | — | 1.11 | 8.87 | 3.78 | — | 2.8 | 3 |
| Ex. 4 | | | | | | | | | |

1. A colorant composition, comprising
i) one or more metallocene polyolefin waxes,
ii) one or more waxes selected from the group consisting of polar non-metallocene polyolefin and non-polar non-metallocene polyolefin waxes, and
iii) optionally, one or more copolymers of ethylene,
iv) and one or more finely dispersed colorants, wherein the colorant composition comprises at least 15% by weight, based on the total weight of the colorant composition, of waxy copolymers of ethylene or both, and in that the copolymers, or both waxes present in the colorant composition comprise at least 50% by weight of polypropylene metallocene wax.

2. The colorant composition as claimed in claim 1, wherein the waxes, copolymers of ethylene or both of components i), ii), and iii) melt at temperatures in the range from 50 to 150° C.

3. The colorant composition as claimed in claim 1, wherein the drop point of the polypropylene metallocene wax is from 80 to 150° C. and its melt viscosity at 170° C. is from 30 to 3000 mPa·s.

4. The colorant composition as claimed in claim 1, wherein the colorant composition comprises from 7.5 to 42.5% by weight, of the polypropylene metallocene wax, from 0.1 to 30% by weight, of the one or more non-metallocene waxes or copolymers of ethylene or both, from 30 to 85% by weight, of the one or more colorants, and from 0 to 15% by weight of fillers or additives.

5. The colorant composition as claimed in claim 1, wherein the one or more colorants are selected from the group consisting of inorganic pigments, organic pigments or a mixture thereof.

6. The colorant composition as claimed in claim 1, wherein the one or more inorganic pigments are selected from the group consisting of the following materials suitable for pigmentation: metal oxides, mixed oxides, aluminum sulfates, chromates, metal powders, pearl-luster pigments, mica, luminescent colors, titanium oxides, cadmium-lead pigments, iron oxides, carbon black, silicates, nickel titanates, cobalt pigments, and chromium oxides.

7. The colorant composition as claimed in claim 6, wherein the colorant composition comprises from 7.5 to 30% by weight, of the polypropylene metallocene wax, from 7.5 to 20% by weight of the one or more non-metallocene waxes, copolymers of ethylene or both, from 60 to 85% by weight, of the one or more inorganic pigments, and from 0.1 to 2% by weight of fillers or additives.

8. The colorant composition as claimed in claim 1, wherein the one or more organic pigments are selected from the group consisting of azo pigments, disazo pigments, laked azo pigments, laked disazo pigments, polycyclic pigments, phthalocyanine pigments, quinacridone pigments, perylene pigments, dioxazine pigments, anthraquinone pigments, thioindigo pigments, diaryl pigments, and quinophthalone pigments.

9. The colorant composition as claimed in claim 8, wherein the polypropylene metallocene wax is mainly or completely amorphous and wherein the colorant composition comprises from 7.5 to 42.5% by weight of the mainly or completely amorphous polypropylene metallocene wax, from 0.1 to 30% by weight of the one or more non-metallocene waxes, copolymers of ethylene or both, from 30 to 75% by weight of the one or more organic pigments, and from 0 to 4% by weight of fillers or additives.

10. The colorant composition as claimed in claim 1, wherein the one or more non-metallocene polyolefin waxes selected from the group consisting of EVA waxes oxidized waxes and mixtures thereof. whose drop point is below 120° C. and whose viscosity is smaller than 1000 mPa·s (measured at 140° C.).

11. The colorant composition as claimed in claim 1, wherein the polypropylene metallocene wax is mainly or completely amorphous. and wherein the colorant composition comprises the mainly or completely amorphous polypropylene metallocene wax, and one or more metallocene copolymer waxes composed of propylene and from 0.1 to 50% by weight of one or more further monomers selected from the group consisting of ethylene and from branched or unbranched 1-alkenes having from 4 to 20 carbon atoms.

12. The colorant composition as claimed in claim 1, wherein the polypropylene metallocene wax is mainly or completely amorphous, and wherein the colorant composition comprises the mainly or completely amorphous polypropylene metallocene wax, and one or more metallocene copolymer waxes composed of propylene and from 0.1 to 50% by weight of one or more further copolymers of ethylene.

13. A process for preparation of a colorant composition as claimed in claim 1, wherein the polypropylene metallocene wax is mainly or completely amorphous and wherein the process comprises the steps of:
a) mixing the individual components i), ii), iv) and optionally iii) to form a mixture and wherein the individual components i), ii), iv), and optionally iii) are cold before mixing, or
b) heating the mixture via mechanical mixing to a temperature of from 15 to 5 K below the softening point of the mainly or completely amorphous polypropylene metallocene wax, and
c) cooling the mixture to a temperature of from 10 to 30° C.

14. A process for preparing a masterbatch comprising the step of mixing a colorant composition as claimed in claim 1 with a polymeric carrier.

15. The process as claimed in claim 14, wherein the mixing takes place at a temperature in the range from 80 to 140° C.

16. The process as claimed in claim 14, wherein the mixing takes place with use of in a corotating twin-screw system.

17. The process as claimed in claim 16, wherein the twin-screw system is operated with a screw profile which has been selected for free-flowing melts.

18. The colorant composition as claimed in claim 1, wherein the colorant composition comprises from 8.5 to 40% by weight, of the polypropylene metallocene wax, from 0.5 to 25% by weight, of the one or more non-metallocene waxes or copolymers of ethylene or both, from 35 to 80% by weight, of the one or more colorants, and from 0 to 15% by weight of fillers or additives.

19. The colorant composition as claimed in claim 6, wherein the colorant composition comprises from 12.5 to 20.5% by weight, of the polypropylene metallocene wax, from 7.5 to 20% by weight of the one or more non-metallocene waxes, copolymers of ethylene or both, from 79 to 85% by weight, of the one or more inorganic pigments, and from 0.1 to 2% by weight of fillers or additives.

20. A masterbatch made in accordance with the process of claim 14.
